(19) United States
(12) Patent Application Publication
(10) Pub. No.: US 2013/0111001 A1
(43) Pub. Date: May 2, 2013

(54) System And Method For Creating And Communicating Freely Associated Collection To Share Information

(71) Applicants: David B. Hamilton, Milpitas, CA (US); Naveen Kondapalli, San Ramon, CA (US); William Tanaka, San Jose, CA (US)

(72) Inventors: David B. Hamilton, Milpitas, CA (US); Naveen Kondapalli, San Ramon, CA (US); William Tanaka, San Jose, CA (US)

(73) Assignee: BROCADE COMMUNICATIONS SYSTEMS, INC., San Jose, CA (US)

(21) Appl. No.: 13/285,918

(22) Filed: Oct. 31, 2011

(51) Int. Cl. G06F 15/173

(52) U.S. Cl. 709/223

(57) ABSTRACT

A network management application implemented in a mobile device which includes a feature for capturing a screen along with information associated with the screen and observed in the application. The capturing feature allows a user to capture a displayed image along with contextual data associated with the image. The user can then share the captured image and data with others to assist in analysis, diagnosis, and other decision making tasks.

### TECHNICAL FIELD

The present invention relates to the field of computer programs used to support human decision making and diagnostics, and in particular to improved techniques in computer programs used for management of computer networks.

### BACKGROUND

Many of today's computer software programs include features for displaying information related to one or more elements of interest in the program Most of these programs are designed to present screen displays to the user operating the program and to enable the user to observe and/or manipulate the displays. Although the software programs are able to display a wide variety of information, it is generally the human user that has the intelligence to identify information that is relevant to the problem at hand and the decisions that need to be made. One of the systems in which such computer programs are utilized are Storage area networks (SANs).

Storage area networks are typically implemented to interconnect data storage devices and servers or hosts, using network switches to provide interconnectivity across the SAN. SANs may be complex systems with many interconnected computers, switches, and storage devices. The switches are typically configured into a switch fabric, and the hosts and storage devices are connected to the switch fabric through ports of the network switches that comprise the switch fabric. Most commonly, Fibre Channel (FC) protocols are used for data communication across the switch fabric, as well as for the setup and teardown of connections to and across the fabric, although these protocols may be implemented on top of Ethernet networks. Other protocols such as the Internet Protocol storage (IP) may also be used.

Network computing systems such as SANs and/or Local Area Networks (LANs) typically require a variety of devices to construct and maintain a working storage system. Given the potential complexity of a network, network operators and enterprises often invest a great deal of time and money managing and maintaining their networks. In the past they usually supervised, monitored, and maintained their networks at a network operations center (NOC). A typical NOC is a room containing visualizations of the network or networks that are being monitored. The NOC may have workstations that show graphical representations of the network and provide a detailed and near real-time status of the network. In most cases, the network operations center would be the focal point for network troubleshooting, performance monitoring, third party network coordination, software maintenance and distribution, as well as router and domain name management. However, managing a network from a central location requires constant presence at such a location. If network problems occur after work hours, troubleshooting may have to wait till the next day, or a network administrator has to travel to the site after hours to troubleshoot the problem. This is both inconvenient and inefficient. Moreover, network administrators inspecting a remote or local device may come across information that they need to share with other network administrators for quick diagnosis and repair. Presently, the only way of sharing this information is calling the other person or sending them an email. This can be time consuming as one network administrator has to verbally describe the situation or problem that he/she has come across.

Thus, what is needed is a network management application which provides capabilities for an improved method of gathering and communicating information.

### SUMMARY

In one embodiment, a network management application is disclosed. The network management application can be implemented in a mobile device and includes a feature for capturing a screen and information associated with the screen and observed in the application. The capturing feature allows a user to capture a displayed image along with contextual data associated with the image. The user can then share the captured image and data with others to assist in analysis, diagnosis, and other decision making tasks that may be required in managing and maintaining the network.

### BRIEF DESCRIPTIONS OF THE DRAWINGS

FIG. 1 is a diagram illustrating an exemplary mobile device on which, according to one embodiment, the network management application of the present invention can be implemented.

FIG. 2 is a diagram illustrating an exemplary login page for using the network management application according to one embodiment.

FIG. 3 is a diagram illustrating a home page of the network management application according to one embodiment.

FIG. 4 is a diagram illustrating an exemplary Event Log according to one embodiment.

FIGS. 5A-5B are diagrams illustrating exemplary Product and Port Lists in a network according to one embodiment.

FIG. 6A is a diagram illustrating an exemplary Port View of the network management application according to one embodiment.

FIG. 6B is a diagram illustrating a Facts capturing menu according to one embodiment.

FIG. 7 is a diagram of an exemplary Fact List according to one embodiment.

FIG. 8 is a diagram illustrating a Facts sharing menu according to one embodiment.

FIG. 9 is a diagram illustrating a Facts editing menu according to one embodiment.

### DETAILED DESCRIPTIONS

Managing SANs and LANs is a complex task that involves many different functions. Network managers and administrators are generally responsible for troubleshooting and performance monitoring, network coordination, and software maintenance and distribution across an entire network. Troubleshooting individual devices within the network may require these administrators to visit each device. This means that network administrators may have to spend a significant amount of their working hours away from the network operations center. This, along with the fact that network problems can occur after regular work hours, means that managing a large network solely from the network operations center is neither practical nor efficient. To address this problem, network management applications have been developed that can be used on portable devices. One such application is a mobile client application developed for use on a mobile phone.

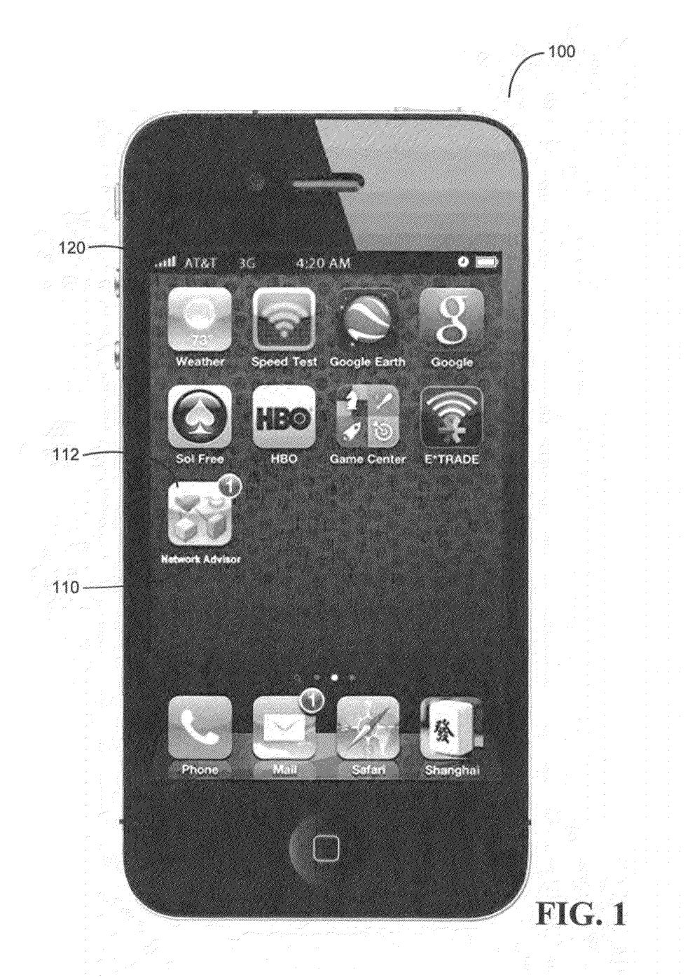

FIG. 1 illustrates an exemplary screen view 120 of a mobile phone 100 implementing such a network management application. As can be seen, the mobile phone 100 includes a mobile client application referred to as the Network Advisor no and accessible through the Network Advisor icon 112. As is well known in the art, the mobile phone 100 includes a processor (not shown) that runs the network advisor no and a memory (not shown) on which the network advisor application is stored. Although the mobile phone 100 illustrated in FIG. 1 is an iPhone®, it should be noted that any mobile phone with sufficient computing capabilities can be used. The Network Advisor no can also be implemented in other portable devices such as tablets, portable computers, and the like. The features and capabilities of this Network Advisor can also be incorporated in other network management applications implemented on any desired type of computational device.

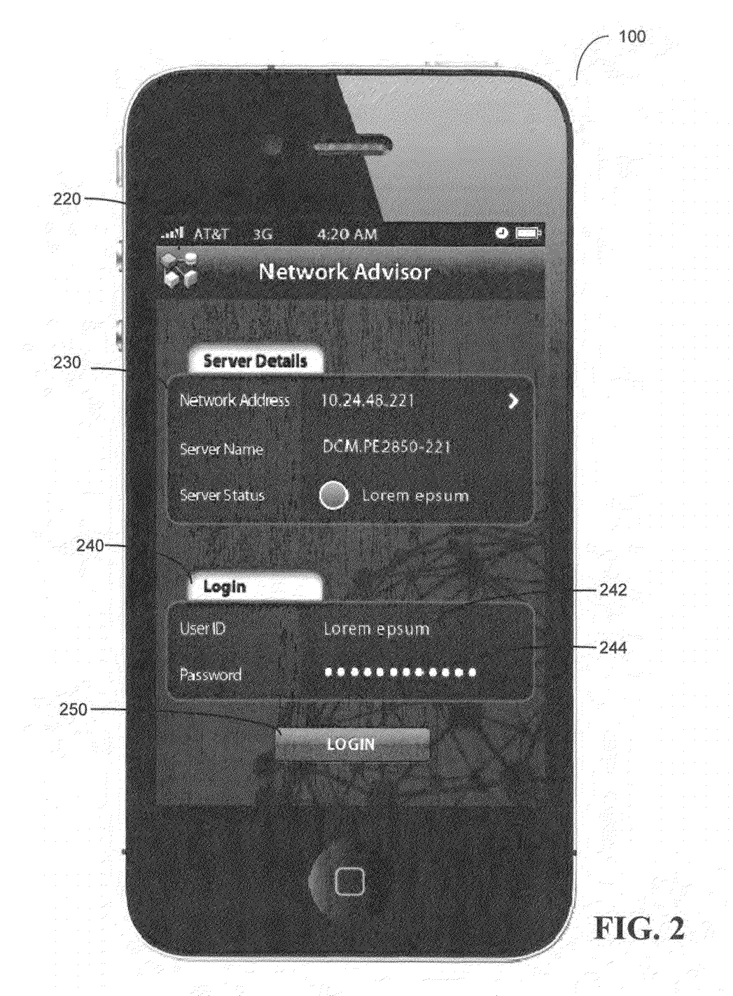

Touching the Network Advisor icon 112 takes the user to the exemplary screen 220 of FIG. 2. The screen 220 constitutes the login page for the Network Advisor no and includes two portions. A server portion 230 illustrates information about the server that is being contacted and a login portion 240 is used for logging in to the user's account. The server portion 230 includes the server's network address, the server name and the server's status. The login portion 240 includes spaces for the user to enter a user ID 242 and a password 244 to enable the network advisor to verify the user's credentials before granting access. Once, the user enters his/her user ID 242 and password 244, the user can touch the LOGIN button 250 to log in to the application.

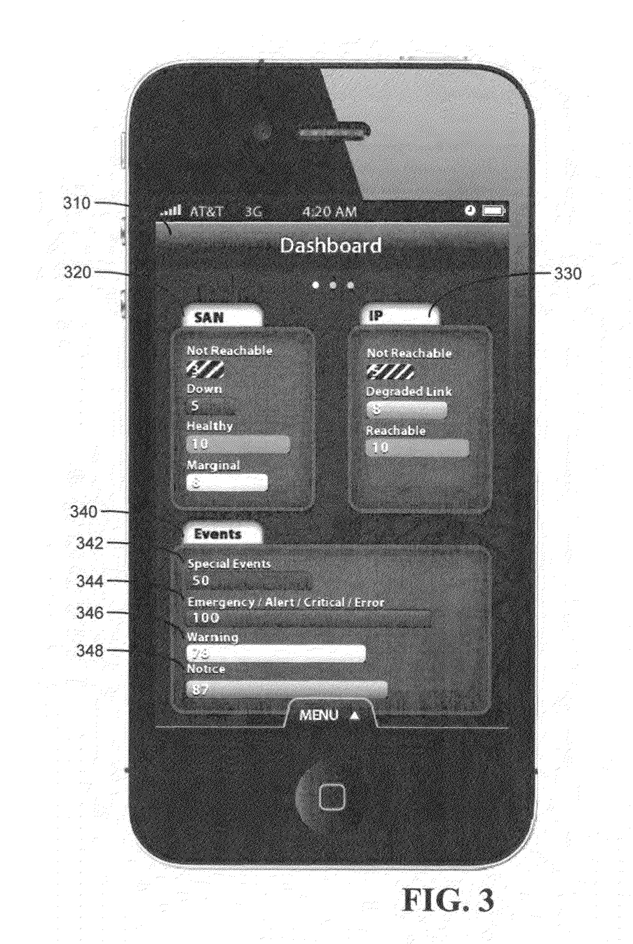

Once the user's credentials are verified and the network advisor 110 determines that the user is authorized to access the program, the network advisor brings up the main menu page of the application, as illustrated in FIG. 3. The main menu of the network advisor 110 is referred to as the Dashboard 310 and includes three panels containing information about one or more SANs, IP networks, and/or other networks to which the user has access through the network advisor. The SAN portion 320 displays a distribution bar chart of operational status with a touchable bar for each observed status. The IP portion 330 displays a distribution of reachability status with touchable bars for each observed status. The SAN portion 320 and the IP portion 330 provide an overall status of the network at a glance and notify the user of potential problems, such as switches with down or marginal status. Touching the bars on the SAN portion 320 or the IP portion 330 takes the user to screens that provide a list of the switches with that status.

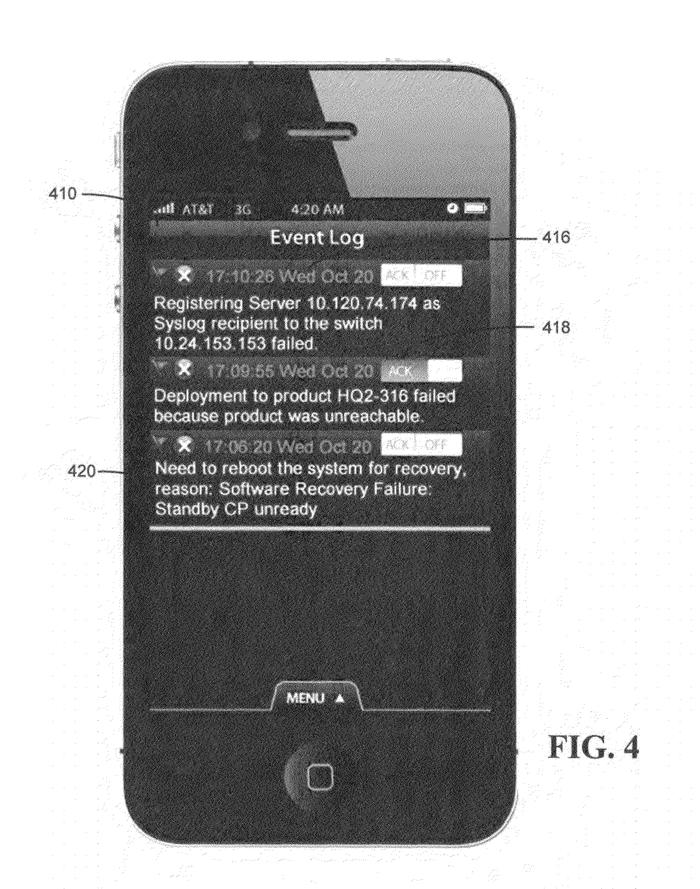

An Events portion 340 shows a summary of particular events in one or more of the networks of which the user might need to be aware. For example, the events portion 340 includes bars for Special Events 342, Emergency/Alert/Critical/Error (EACE) events 344, Warnings 346, and Notices 348. Touching any of these bars takes the user to a separate screen, which provides a list of the events in the particular category along with more information about each event. Such a screen is illustrated in FIG. 4.

The screen 410 of FIG. 4 provides a scrollable list of events. The list consists of rows of varying height. Each row includes an event icon 412, a severity icon 414, a client time stamp 416, an acknowledged state/control (ACK) 418, and an event description 420. The severity icon 414 is indicative of the severity of the event and the client time stamp 416 indicates the time the event occurred. Touching the header or description area of an event takes the user to a screen displaying that event's properties and detailed information.

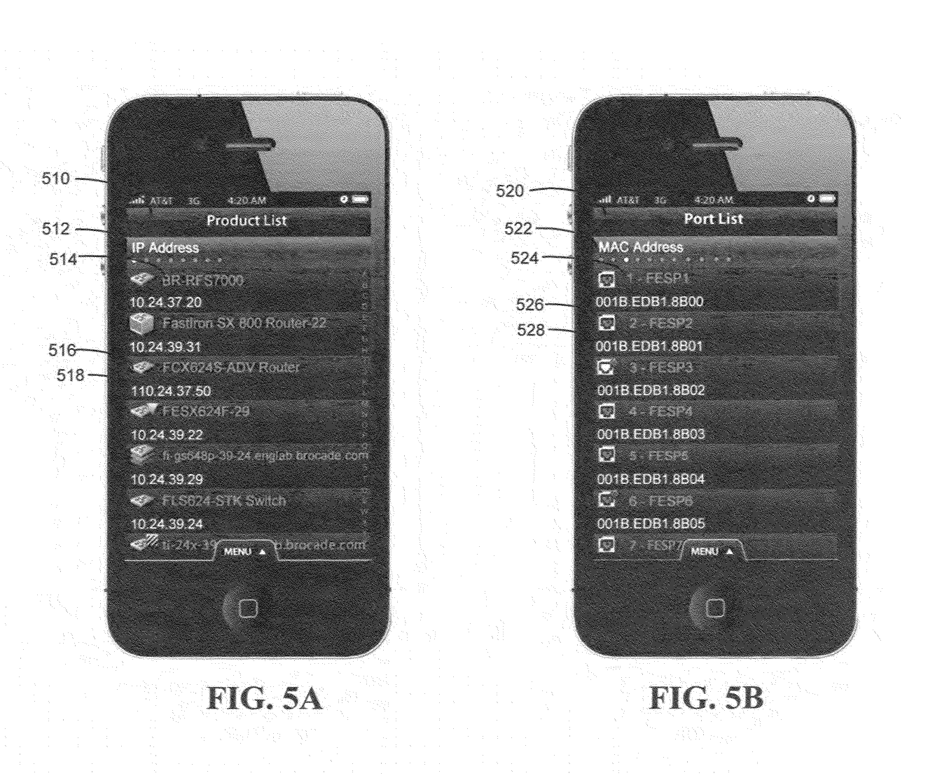

The network advisor no offers numerous other options for viewing and managing the network devices. For example, the network advisor no provides an option to view the list of products in the network. An exemplary product list is illustrated in the Product List 510 of FIG. 5A. The Product List 510 displays a list of products along with one product attribute for each product. This allows for the comparison of an attribute across many products in the network. The attribute displayed for each page view is listed at the top of the list. For example, for the Product List 510, the attribute IP Address 512 is displayed on the bottom of each entry. The list may be horizontally or vertically scrollable. For example, the list may be vertically scrollable to allow the user to view the entire list, and horizontally scrollable to view other attributes of the same products. Each row in the product list 510 includes a product identifier or name 514, a product icon 516, and a product attribute value 518. Touching any row takes the user to a page (not shown) displaying detailed information about that product. The product's detailed information may include the product's performance, power supplies, events, attached products, and ports. Touching each of those options takes the user to a page with more detailed information about that option. For example, touching Ports, takes the user to a page providing a list of ports for that product, such as the Port List 520 illustrated in FIG. 5B.

The Port List 520 displays a list of ports along with one port attribute for each port on the list. For example, the Port List 520 displays the attribute MAC Address 522 for each of the ports. The list may be horizontally or vertically scrollable. For example, the list may be vertically scrollable to allow the user to view the entire list, and horizontally scrollable to view other attributes of the same ports. Each row in the Port List 520 includes a port identifier or name 524, a port icon 526, and a port attribute value 528. Touching any row takes the user to a page displaying detailed information about that port.

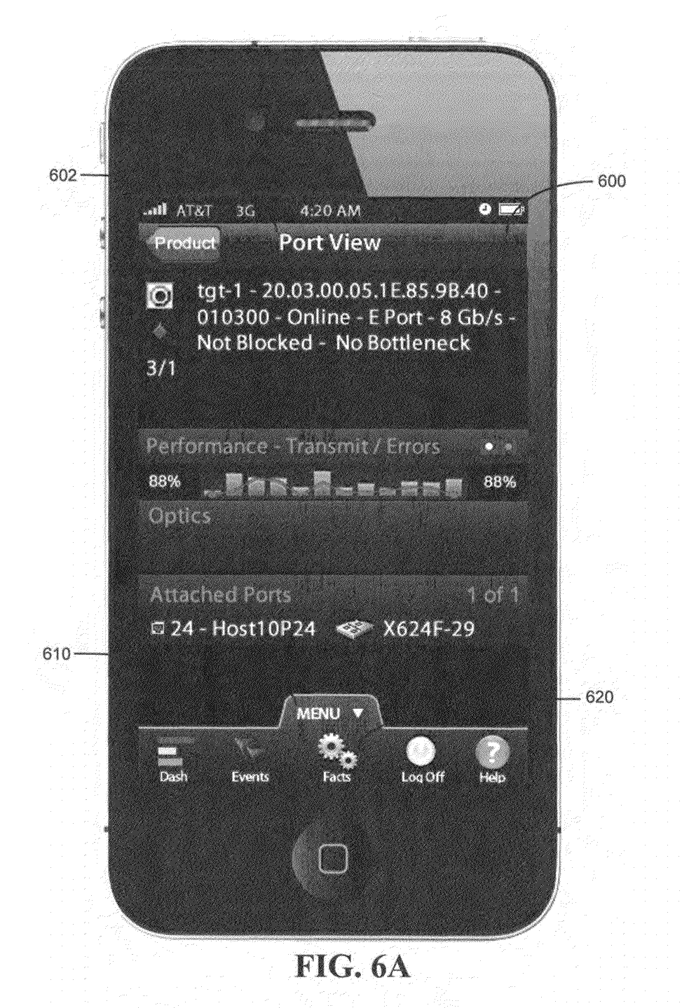

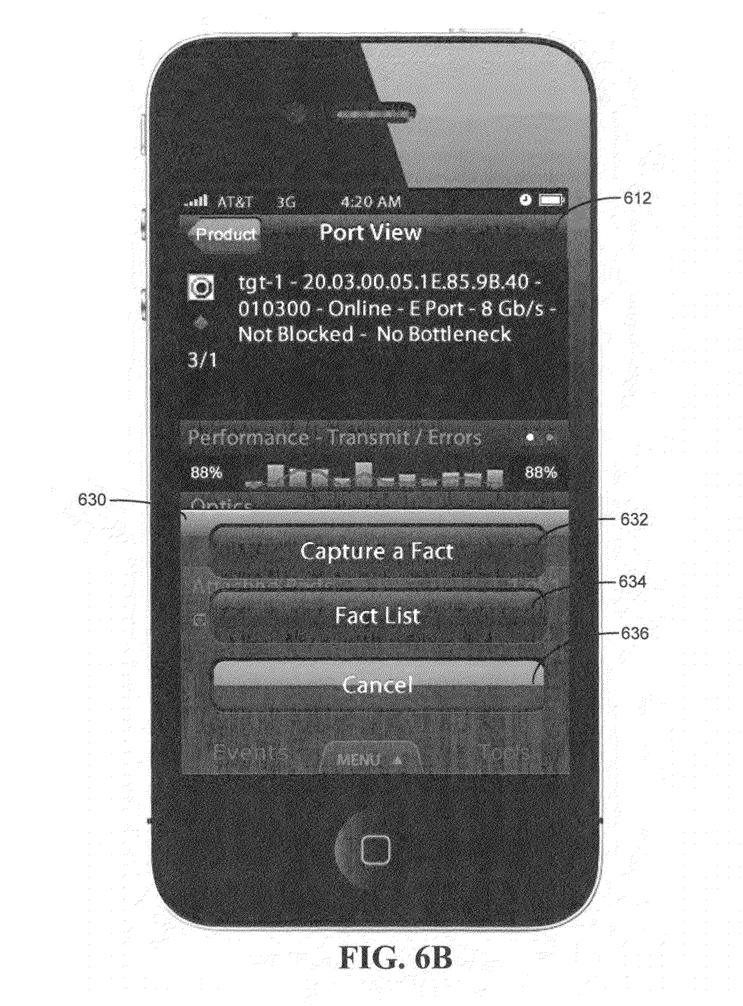

Event Log 410, Product List 510, and Port List 520, along with other features included in the network advisor no provide the network administrator with numerous options and capabilities for managing and reviewing the network efficiently from a remote location. However, if while using the network advisor no the network administrator comes across information that needs to be shared with a second network administrator, the network administrator would still need to go through the inefficient and time consuming task of calling the second administrator and trying to explain exactly what he/she has come across. In addition, in coming across a port, a product, or any other information in the network advisor no, the administrator may need to store important information about the particular device he/she is viewing for future reference. The preferred embodiment of the present invention presents a solution to this issue by incorporating a functionality that allows the user to capture, store and share the contents of any screen displayed. This feature provides the user with the ability to capture displays and data from the application and share them with others. For example, while viewing the screen 600 of FIG. 6, the user may decide that facts and information about this port's status and operation at this particular point need to be stored for reference in the future. The user is able to touch the menu icon 610 at the bottom of the screen to bring up the list of menu items available in that screen. One of the items in the menu is labeled as Facts. Touching the Facts (Freely Associated Collection To Share) icon 620 displays a Facts menu 630 as shown in FIG. 6B.

The Facts menu 630 includes a button 632 for capturing a Fact, a button 634 for displaying the Fact List and a button 636 for canceling the Facts operation. Touching the button 632 enables the user to capture the screen 600 along with all its contents and associated data. Capturing a screen in this manner includes not only taking and storing a screenshot of the screen, but also capturing and storing contextual data associated with the screen. The contextual data may be any information displayed or embedded in the screen. The contextual data may include data such as the type of view presented in the screen, e.g. a port view, the time and date the screen was captured, and any numerical data displayed in the screen. For example, information such a current configuration or status of a product or port, a graph of the current data flowing through a port, or a critical event that has occurred in the network may be captured in addition to the image of the screen. Examples of other information that can be captured include results of the tools that can be called from the Network Advisor such as, the ping, trace route output, system logs (or portions of them), and a switch CLI output. Other contextual data may include physical location of the port or product from which the Fact is captured. The type of contextual data captured with each screen is generally predetermined in the network advisor no.

In addition to the contextual data, sometimes the user may need to input further information for future reference. For example, a user that reviews and captures numerous port views for future review, may need to record a note as to further actions required for each port view captured. This is achieved, in one embodiment, by enabling the user to create a text note that is stored as one of the contextual data associated with the captured Fact. In another embodiment, the user is able to add a voice note. The voice note is created by enabling the user to take advantage of the mobile phone's voice recording feature to record a voice note and then store and associate the voice note along with the rest of the contextual data for the captured Fact. In yet another embodiment, the user can create and add a video note. The video note is created by using the mobile phone's video recording application and by storing the video with the rest of the contextual data for the captured Fact. The voice, video and/or text note can be added after a Fact is captured. In one embodiment, after the user presses the button 632 for capturing a Fact, the user is presented with an option (not shown) to input a text note, a voice note, a video note or all three. Choosing the text note takes the user to a text box where text can be input. Selecting the voice note takes the user to a voice recording page where a voice note can be recorded and choosing the video note takes the user to an application that can record a video

In addition to the ability to add text, voice or video notes, the user is also able, in one embodiment, to choose the type of contextual data desired to be captured along with a Fact. For example, the user can choose to capture the type of view captured, and the date it was captured, but not the time. The selection of which contextual data to capture with a screen can be made either when the user first sets up the network advisor for use on his/her device, or each time a Fact is captured. If the user makes the selection when he/she first sets up the network advisor, the user can also select the type of contextual data captured for each specific type of Fact. For example, the user may choose to capture a graph of current data flowing through a port if the type of Fact is a port view, and may select to capture a graph of a product's performance if the type of Fact is a product view.

After a Fact is captured, the captured screenshot along with its associated contextual data are stored in the network advisor no and placed in a Fact List. The Facts menu 630 then disappears and the screen 612 reverts to its previous view, screen 600, such that the user can continue with their previous task.

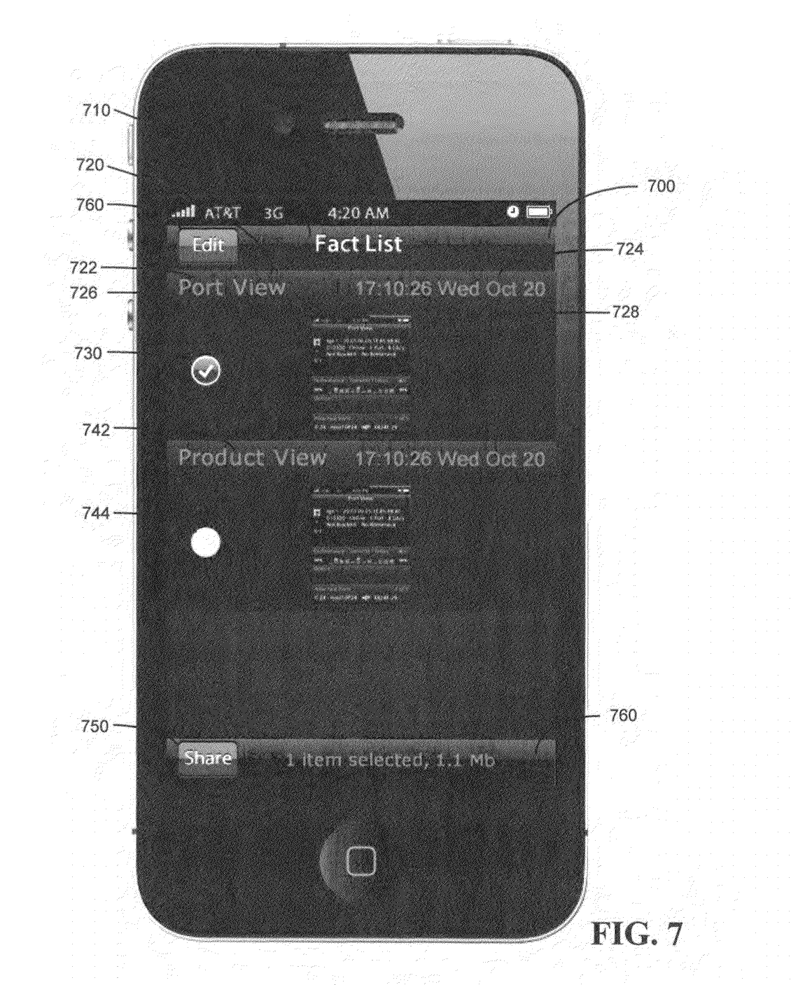

At any time the user desires to visit a Fact previously captured, the user can touch the menu icon 610 at the bottom of the screen 600 to display the list of menu items available in that screen and then touch the Facts icon 620 to display the Facts menu 630 (shown in FIG. 6B). Once the Facts menu is displayed, the user can press the Fact List button 634 to be taken to the list of Facts. An exemplary Fact List 720 is illustrated in the screen 700 of FIG. 7. As can be seen the Fact List 720 includes a list of all Facts captured and stored in the application. The screen 700 is scrollable vertically to view more Facts. The list of Facts may be displayed chronologically in accordance with the dates they were captured, or they may be displayed alphabetically or according to their type. In one embodiment, the user is able to choose the type of view for displaying the Facts. If the Fact List is displayed in accordance with the type of Facts, e.g. Port view, Product view, etc., the screen 700 may be scrollable vertically and horizontally. The horizontal scroll allows the user to move through various types of Facts, while the vertical screen enables the user to view all of the Facts listed under the one of type of Fact presented on that page. In one embodiment, the user is able to rearrange the order by which Facts are displayed by dragging the Facts up or down in the Edit mode.

Each Fact in the Fact List includes an image of the Fact's screenshot along with its' contextual data captured with the Fact. For example, the Fact 720 displays the type of Fact 722 and the time and date of capture 724 in a header portion 726, and displays an image 728 of the Fact's screenshot below the header portion 726. Touching the header 726 or image 728 takes the user to a screen displaying only the Fact 720 (not shown). This screen displays the Fact 720 in more detail and also provides options for viewing any added text notes, listening to any added voice notes, or viewing any added video notes. In one embodiment, this Fact screen provides the user with an ability to edit the selected Fact. For example, the user may be able to edit the text note, voice or video note associated with the Fact, or may be able to add a text, video and/or a voice note. In another embodiment, the user is able to edit some of the contextual information associated with the Fact. In yet another embodiment, the user may be able to choose to delete the Fact entirely, or select specific contextual data associated with the Fact to delete.

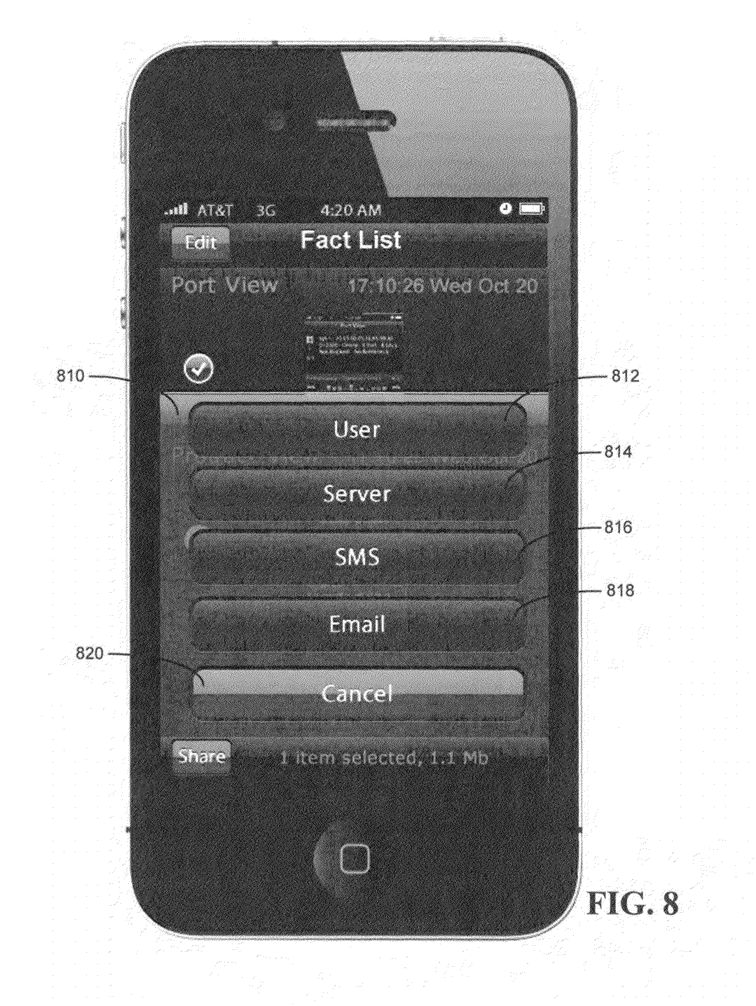

Referring back to screen 700 of FIG. 7, touching the checkmark 730 in screen 700, selects the Fact 722, and touching the checkmark (circle) 744 selects the Fact 742. Touching the checkmark next to the Fact, after it has been selected, deselects the Fact. In one embodiment, two or more Facts may be selected at the same time. A footer panel 760 displays the size in Megabytes of the currently selected Facts. After a Fact is selected by touching its' corresponding checkmark, the user can press the Share button 750 to share the selected Fact. Pressing the Share button 750 displays the Share menu 810 of FIG. 8.

The share menu 810 enables the user to share the selected Fact(s) through one or more different sharing methods. The user can select to share the Fact by pressing the User button 812, the Server button 814, the SMS button 816, or the Email button 818. Pressing the User button 812 takes the user to a screen displaying a list of users defined on the network advisor server (the server being the one connected to through the network advisor login 240), where one or more users of the server, e.g., other network administrators, can be selected. Once one or more other users are selected, the Facts are sent to the Network Advisor server and appear in the selected users' fact lists.

Facts can also be shared by pressing the Server button 812 which posts the Facts to the server's system Facts List. The system Facts list is a list of Facts maintained by the server. This system Facts list is compiled of Facts submitted or published to the server by its users. Users of the server can view all Facts in the system Facts list. The user can also select to share the Fact by emailing and/or sending it via a text massage. The SMS button 816 takes the user to the mobile phone's text massaging window where the user can select a phone number to send the Fact to. When sent as a text message, the Fact is attached as an image that includes the Fact's screenshot along with its' contextual data. If the Fact includes a text, voice or video note, the user may choose to add the associated text, voice or video note to the text massage. The user can also input any text he/she desires, as done with a normal text message.

When the user selects to share the Fact through email by pressing the Email button 818, a new email message window opens in the mobile phone's default email program. The user may also be presented, in one embodiment, with a list of email programs to choose from for sending the email. Once presented with a new email message window, the user can select or input an email address or an email group to send the email to and can modify the body of the email as he/she desires. Again, the user can also select to include an associated voice, video or text note. In instances where the user decides against sharing the Fact after presented with the Share menu 810, the user can choose to cancel sharing by pressing the Cancel button 820. Once pressed, the cancel button 820 takes the user back to the screen 700.

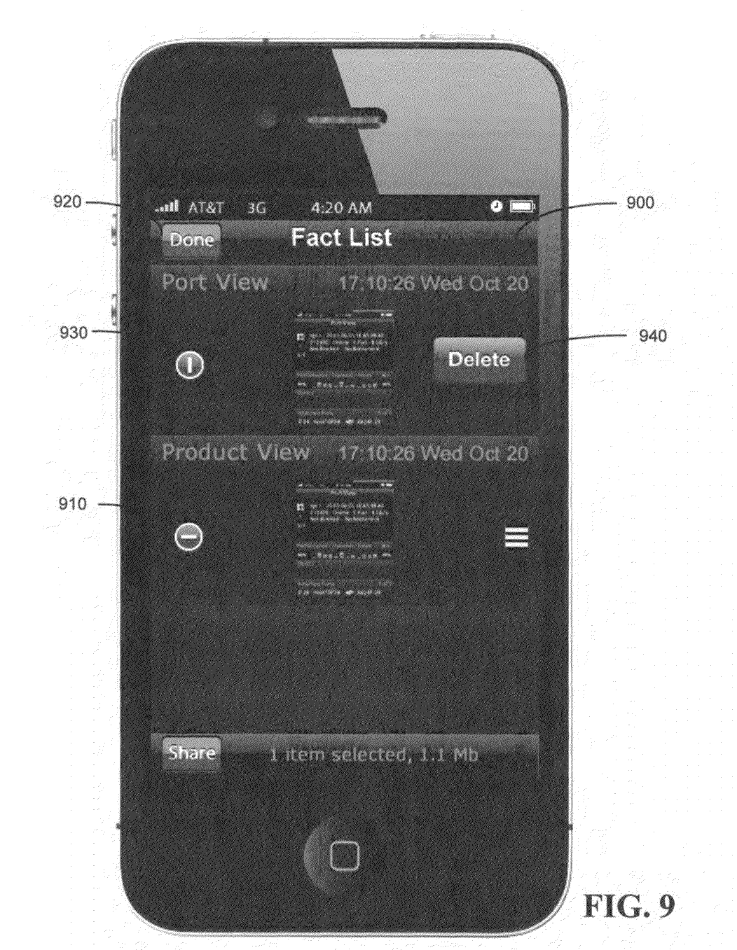

In the screen 700, the user is able to edit the Fact List by pressing the Edit button 760. After pressing the Edit button 760, the user is presented with the screen 900 of FIG. 9. In the edit mode, each Fact in the list is displayed with a minus sign, such as the sign 910. The Edit button 760 also changes to a Done button 920. If the user touches a minus sign, the minus sign rotates 90°, as can be seen with the minus sign 930, and a Delete button 940 appears in the body of the Fact for which the minus sign was pressed. Pressing the Delete button 940 removes that Fact from the Fact List. In one embodiment, a warning window appears after pressing the Delete button 940 to confirm that the user intends to delete the Fact. Pressing the Done button 920 exits the edit mode and takes the user back to the screen 700, with the exception that any deleted Fact does not appear in the Fact List 720.

Accordingly, any screen image in the network advisor 110 can be captured along with the screen image's associated contextual data. The captured screen images and their associated contextual data can be viewed, shared, and edited at any time in the future. Although described in the context of a mobile network management application, the capture feature disclosed in the above description can be included in any network management application. Moreover, the capture feature can be implemented in other types of applications. For example, a similar feature may be implemented in the Windows operation system, in which when capturing a screenshot, contextual data such as the time and date of the capture may be included in the captured image. The feature can also be used when visiting websites on the Internet or when using other applications on a mobile device. For example, a day trader using a stock analysis application may be able to capture an image displaying statistics for a particular stock and capture associated contextual information for that image such as the date and time of capture, the type of view, and any graph displayed in the image. The day trader is then able to save this Fact for future reference or pass that along quickly to others for further analysis and review.

It should be noted that any reference to touching a button or an item on a screen in the above description incorporates clicking on the item in devices that either do not operate with a touch screen or provide the capability to both use a clicking device and a touch screen.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the frill scope of equivalents to which such claims are entitled. In the appended claims, the terms “including” and “in which” are used as the plain-English equivalents of the respective terms “comprising” and “wherein.”

What is claimed is:

1. A method for managing a computer network comprising:
accessing a first page displaying information about the network on a first device;
capturing a screen image of the first page along with contextual data associated with the first page;
storing the captured screen image and the associated contextual data on the first device; and
displaying on the first device a second page; the second page comprising the stored screen image along with its associated contextual data.

2. The method of claim 1, further comprising sharing the stored screen image and its associated data with a second device.

3. The method of claim 1, further comprising emailing the stored screen image and its associated data to a user of a second device.

4. The method of claim 1, further comprising sending the stored screen image and its associated data to a user via a telephone text message.

5. The method of claim 1, further comprising displaying a list of stored screen images and their associated contextual data.

6. The method of claim 5, further comprising editing the list of stored screen images and their associated contextual data.

7. The method of claim 1, further comprising selecting by a user which contextual data associated with the first page to capture.

8. The method of claim 1, wherein the first device is a mobile device.

9. A machine-readable storage medium on a first device comprising software that causes a processor to:
access a first page on the first device; the first page displaying information about a computer network;
capture a screen image of the first page along with contextual data associated with the first page;
store the captured screen image and its associated contextual data on the first device; and
display a second page on the first device; wherein the second page comprises the stored screen image along with the stored screen image's associated contextual data.

10. The machine-readable storage medium of claim 9, wherein the processor is configured to share the stored screen image and its associated data with a second device.

11. The machine-readable storage medium of claim 9, wherein the processor is configured to email the stored screen image and its associated data to a user of a second device.

12. The machine-readable storage medium of claim 9, wherein the processor is configured to send the stored screen image and its associated data to a user via a telephone text message.

13. The machine-readable storage medium of claim 9, wherein the processor is configured to display a list of stored screen images along with their associated contextual data.

14. The machine-readable storage medium of claim 12, wherein the processor is configured to edit the list of stored screen images and their associated contextual data.

15. A method of capturing a screen image of a screen displayed on a first device comprising:
capturing a screen image of the displayed screen;
capturing contextual data associated with the displayed screen;
linking the screen image with the associated data;
storing the linked screen image and associated contextual data; and
displaying the stored screen image along with its linked associated contextual data.

16. The method of claim 15, further comprising sharing the stored screen image and its linked associated contextual data with a second device.

17. The method of claim 15, further comprising emailing the stored screen image and its associated contextual data to a user of a second device.

18. The method of claim 15, further comprising sending the stored screen image and its associated contextual data to a user via a telephone text message.

19. The method of claim 15, further comprising displaying a list of stored screen images and their associated contextual data on the first device.

20. The method of claim 19, further comprising editing the list of stored screen images and their associated contextual data.

21. The method of claim 15, further comprising selecting by a user which contextual data associated with the displayed image to capture.

22. A device configured for managing a computer network, the device comprising:
a processor, and
a memory coupled to the processor;
wherein the processor is configured to:
access a first page displaying information about the network;
capture a screen image of the first page along with contextual data associated with the first page;
store the captured screen image and the associated contextual data in the memory; and
displaying a second page; the second page comprising the stored screen image along with its associated contextual data.

23. The device of claim 22, where the processor is further configured to share the stored screen image and its associated contextual data with a second device.

24. The device of claim 22, further comprising displaying a list of stored screen images and their associated contextual data.

25. The device of claim 24, further comprising editing the list of stored screen images and their associated contextual data.

26. The device of claim 22, wherein the device is a mobile device.
